(19) United States
(12) Patent Application Publication
(10) Pub. No.: US 2023/0047918 A1
(43) Pub. Date: Feb. 16, 2023

(54) SEALABLE AND AUTOSAMPLER COMPATIBLE MICROAMPULE FOR PACKAGING AND A METHOD FOR PERSEVERING ANALYTICAL AND BIOPHARMACEUTICAL SAMPLES

(71) Applicant: Seyed Mohammadreza JAFARI, Unionville (CA)

(72) Inventor: Seyed Mohammadreza JAFARI, Unionville (CA)

(21) Appl. No.: 17/887,418

(22) Filed: Aug. 13, 2022

Related U.S. Application Data
(60) Provisional application No. 63/232,770, filed on Aug. 13, 2021.

(51) Int. Cl. A61J 1/06; B65B 3/00

(52) U.S. Cl. CPC A61J 1/065; B65B 3/006

(57) ABSTRACT

The present invention is a sealable microampule for storage of environment sensitive material which is autosampler compatible and provides a space, small enough to make low volumes of liquid available for auto-injector needle. The microampule fits inside an autosampler vial and breaks open at a certain height to allow stable accommodation inside the autosampler vial. The microampule has a longer length which provides space to apply the force to snap break the seal at the opening level of the autosampler vial.

### FIELD OF THE INVENTION

The present invention relates in general to packaging technology for pharmaceuticals and in specific to a new type of sealable low volume container for packaging and storing small quantities of solid or liquid, which is compatible with the vials used in standard autosampler machine in analytical instruments.

### BACKGROUND OF THE INVENTION

The biopharmaceutical industry deals with many types of material that are provided in small quantities. This material could range from biological samples such as viruses and proteins to organic and inorganic compounds. Often times the material is sensitive to the environment conditions such as moisture, ambient oxygen and evaporation. Therefore, it is highly important to preserve the material from contacting the ambient air. Many other industries such as environmental testing, diagnostic labs, etc., are in constant need of innovative methods to keep the material safe from environmentally stimulated degradation.

The standard method to preserve the material in a container is to limit the airflow towards the material. Screw capping the container and crimp capping are being used widely because of the ease of use. However, none of these methods can block the flow of air into the sample completely. The best way to protect the material inside a container from the air outside is seamless sealing of the container with airproof material such as glass or plastic. Glass ampules have been successfully used for preserving the specimen for years. In this method, the glass container (such as ampoule) is heated on the top opening until the glass melts and fuses with the body of the container. The advantage of using glass is its ability to seal with heating and their neutrality towards many type of material.

Historically, glass ampules have been designed in a specific shape to fit in the frequent standards machinery for sealing, to fit volumes of liquid more than 0.5 mL and to be opened manually in human's hand. New methods in analytical chemistry use an autosampler device, where a robot uses a needle to aspirate very low volume of liquid (1-10 μl). The autosamplers have adopted standard sizes and functions. The available solutions are multi-well plates, autosampler vials and low volume inserts which can contain the liquid in amounts of 2-200 μl.

The autosampler vials come in many different shapes and sizes among which 8-425, 9-425 and 10-425 are highly popular and can fit up to 2 mL of liquid. When lower volume of liquid is to be aspirated by autosampler needle, a close-end tube named “insert” is placed inside the vial to make the small quantities of liquid available to the autosampler needle.

On the other hand, the standard container for the storage of sensitive material is glass “ampoule” (conventional ampoule) which has a completely different shape, and autosampler robots are not designed to use this type of container. The “ampule” can typically fit 0.5 mL-20 mL of liquid. “Ampoules” with volumes outside this range are not commercially available.

There are many different types of glass tubes in various shapes that serve as a container for storage of perfume and cosmetics. These types of non-conventional ampoules are not being used in pharmaceutical industry and are not meant to be sealed and also are not designed to be used in autosampler systems.

There is a dissociation between the type of containers that are used to store air sensitive chemicals (conventional “ampoules”) and the containers that are used by the autosampler robot in analyze methods (vials and “inserts”).

According to FIG. 1A an ampoule 10 can be sealed and can protect the containment, but it is not usable by autosampler system. As shown in FIG. 1B the screw cap vials 20 with or without inserts, are not sealable. Therefore, they are not the suitable option for the storage of sensitive materials.

Additionally, when low volume of liquid is being taken by the autosampler injector needle a vial is not a proper option, because the liquid spreads on the bottom of the vials and makes a thin layer which makes it difficult for the needle to aspirate the proper amount of liquid.

FIG. 1C shows another ampule 30 which is commercially available to solve the above problem. A glass insert 31 is usually utilized inside a autosampler vial. The small diameter of glass insert increases the height of the liquid and make the liquid accessible to the needle. This nonconformity between the storage “ampoule” and the point-of-use container vial/“insert” system makes two major problems:
a) the user needs to transfer the liquid from the manufacturer sealed ampoule to an autosampler compatible system (vial/“insert”), thus adding an extra step to the procedure, which a) can be highly time-consumable when the number of samples are high. b) increase the inaccuracy due to the transfer procedure.
b) To transfer the liquid, the user has to snap break the ampoule. Once broken, the ampoule cannot be sealed anymore and the user ends up with the remaining of a material that cannot be stored air-proof. This problem often times results in waste of material. If the manufacturer had a solution to distribute the volume of the material in many smaller sealable ampoules (“microampules”), breaking one container would not affect the rest of material. For example, if the user needs only 0.05 mL of the liquid out of a 1.0 mL ampoule, then 0.950 mL of the material would be wasted. While, if the user had a chance to buy 20 sealed “microampule” with 0.05 mL of material in each (total of 1.0 mL), then breaking one “microampule” would not compromise the remaining material in the other 19 “microampules”.

None of the vial/“insert” systems available in the market are designed to be sealable. All of these systems are currently usable only after the liquid is transferred to an open top “insert” by the user, and only usable shortly after transfer. The industry needs a method in which the micro volume container can be sealed in the production stage so that the sample can be preserved from air in long term.

Since a standard 2.0 mL autosampler vial fits larger amount of liquid, often times a glass insert is being used to contain lower amount of liquid. The thinner shape of the insert increases the height of the solution in the container and the injection needle can take volumes down to 1 μl. By slimming the glass “insert” even further (high recovery “insert”) or making a conical shape at the end of the “insert”, the needle can access a minimal volume of liquid available.

In some designs a plastic spring is attached at the bottom of the insert to push the opening of the insert towards the silicone cap of the vial and making a tighter closing. However, a seal tight glass insert is not available. The standard size of an autosampler vial has a height of 32±5 mm and a width of 12±1 mm. This only lets an insert with a height of 32 mm±6 mm to fit in the vial. If the conventional insert is sealed at the top, a large part of the glass wall would be removed by snap breaking and the vial cannot hold in the glass.

To overcome the drawbacks of existing products and preserving capability of “ampoule” with the convenient of autosampler compatible vial/“insert” system, the present invention proposes a “microampule” that can both be sealed on the top and be used inside an autosampler vial right after snap breaking, therefore removing the liquid transfer step while keeping the material intact from manufacturing step to the point of use.

### SUMMARY OF THE INVENTION

The present invention is a novel “microampule” for storage of environment sensitive material which is autosampler compatible and provides a space, small enough to make low volumes of liquid available for auto-injector needle. The microampule is a container made of glass or plastic or other material at certain diameter and length that can be sealed on the top by heating and can be break open at a certain height. The microampule fits inside an autosampler vial and will be break open at a certain height to allow stable accommodation inside the autosampler vial. The microampule can be sealed on the top and used inside an autosampler vial right after snap breaking, therefore removing the liquid transfer step while keeping the material intact from manufacturing step to the point of use.

The innovation lies under the design of a specific shape and size of the ampule which adds a spacer to the top of a regular glass “insert”. In this design, the top portion of the “microampule” works as a spacer to prevent the heat to spread down to the liquid when heat sealing the ampule. Additionally the top portion of the “microampule” acts as a handle: The longer length of the spacer provides a space to apply the force to snap break the seal at the opening level of the autosampler vial.

The microampule (the container) breaks at a certain position on the walls so that its opening aligns with the opening of the autosampler vial for tight screw capping or crimp capping. The microampule is suitable to store air sensitive material such as analytical standards and biopharmaceuticals in volumes under 300 μl.

The method of manufacturing is a simple sealable container made of glass or plastic that is compatible with autosampler systems used in analytical devices such as mass spectrometers. The industry lacks a packaging system that can hold small quantities of liquid in air proof sealed container. The available systems are either non-sealable (screw cap vials), or designed to carry volumes higher than 500 μl. (conventional glass ampules).

The present invention specifically addresses the problem in packaging air sensitive material in low quantities. Using very small quantity of material (1-100 μl) has become a routine only in the wake of ultra-sensitive instrumentations which need tiny amount of analyte for analysis. The focus of reagent suppliers has been on providing higher amount of analyte, rather than lower, in expense of consuming user's time to transfer smaller quantities of analyte (aliquoting) from the larger container (conventional ampoule) into small container (“insert”) before use. Using the present invention, the user can make very small quantity of liquid available for needle pick up without a need to transfer the material from a larger container.

The present invention uses a closed end glass or plastic tube that is slim enough to hold small quantities of liquid in proper height for auto injector needle, while the tube can be used in an autosampler compatible vial acting as a holder. This makes the system: 1) sealable after packaging 2) able to hold small volumes of liquid 3) compatible with autosampler systems.

By using this type of microampule, the liquid is transferred into the “microampule” at the manufacturing facility. At the point of use, the microampule can be inserted inside a vial and snap brake to expose the analyte, totally bypassing any material transfer step. The analyte or the specimen will keep unexposed from the filling/packaging point at the manufacturer's facility until it is ready to be used by the autosampler/autoinjector.

The specifications that is devised in the shape and size of the microampule makes the contained material safe from heat at the sealing step as well as making it fit specifically inside an autosampler compatible vial.

Therefore, it is an object of the present invention to provide “microampules” which can be sealed at the top to protect the containment before opening and which can fit inside a standard autosampler vial after snap breaking.

It is another object of the present invention to make very small quantity of liquid available for needle pick up without a need to transfer the material from a larger container or to the auto-injector.

It is another object of the present invention that any industry or laboratory which uses an autosampler/autoinjector device can benefit from this system, specifically, sensitive analytical standards and biopharmaceutical materials that need to be shipped in sealed systems and in low quantity benefit from the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1A (Prior art) shows a conventional ampoule that can be sealed and can protect the containment;

FIG. 1B (Prior art) shows a screw cap vial with or without inserts;

FIG. 1C (Prior art) shows a glass low volume insert inside a screw cap vial;

FIG. 2 shows the process of manufacturing, packaging and using the microampule of the present invention;

FIG. 3A is a view of a V-shape microampule according to the present invention;

FIG. 3B is a view of a round bottom microampule according to the present invention;

FIG. 3C is a view of a flat bottom microampule according to the present invention;

FIG. 3D is a view of a high-recovery microampule according to the present invention;

FIG. 3E is a view of a spring-attached microampule according to the present invention;

FIG. 4A is a view of a microampule showing the scoring height;

FIG. 4B is a view of a microampule with spring showing the scoring height;

FIG. 5A shows a microampule made independent of the autosampler vial;

FIG. 5B shows the microampule made independent of the autosampler vial and then fused to the autosampler vial;

FIG. 5C shows the microampule made as a part of the autosampler vial;

FIG. 5D shows the microampule in two pieces where a glass micro-lid is placed on the top of the microampule before sealing;

FIG. 5E shows the microampule in two pieces where a glass micro-lid is inserted on the opening of the microampule at the top before sealing;

FIG. 5F shows the microampule in two pieces where a screw/bolt shaped glass micro-lid screwed on the top of the microampule before sealing;

FIG. 6A shows the advantage of adding a top spacer in preventing heat induced degradation of the sample during sealing process;

FIG. 6B shows an embodiment to produce the sealed microampoule according to the present invention;

FIG. 6C shows another embodiment to produce the sealed microampoule according to the present invention;

FIG. 6D shows another embodiment to produce the sealed microampoule according to the present invention, and

FIG. 6E shows another embodiment to produce the sealed microampoule according to the present invention;

FIG. 7A shows the microampule without a spacer which is broke short and did not fit properly in the autosampler vial to show the advantage of adding a top spacer to allow the sealed microampule snap break at the right position to fit in an autosampler vial according to the present invention;

FIG. 7B shows the microampule with a short spacer which upon breaking may cause chopped edges or destroy the microampule to show the advantage of adding a top spacer to allow the sealed microampule snap break at the right position to fit in an autosampler vial according to the present invention, and

FIG. 7C shows the advantage of adding a right length for the top spacer to allow the sealed microampule snap break at the right position to fit in an autosampler vial according to the present invention.

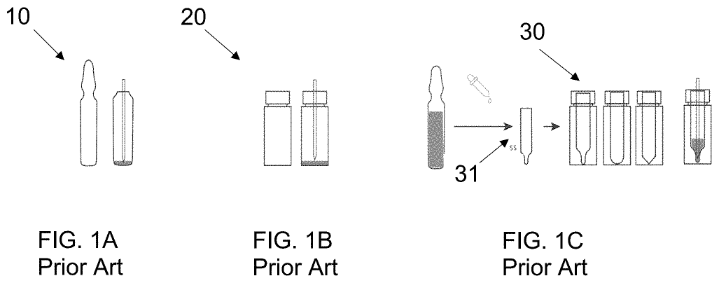

### DETAILED DESCRIPTION OF PREFERRED EMBODIMENTS

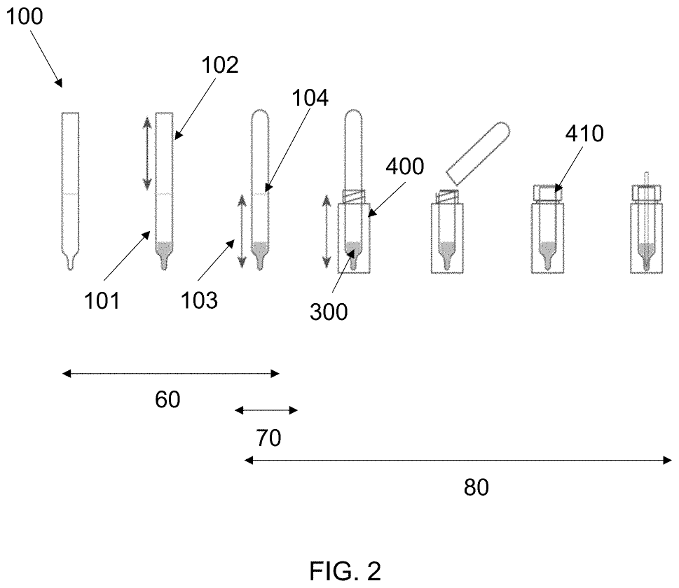

According to FIG. 2 the microampule 100 is a cylindrical container in dimensions and scoring level tubes for analytical autosampler by snap breaking. The microampule can be made of any material including but not limited to any type of glass (borosilicate, lime soda, lead, clear, amber, etc.), plastic, ceramic, etc. The microampule is made by closing the bottom end of a glass tube in various shapes.

The microampule can be sealed on the top and placed inside an autosampler vial and break open at a certain height to be used right after snap breaking, Therefore, removing the liquid transfer step while keeping the material intact from manufacturing step to the point of use.

The microampule has a body comprising an outer diameter (OD) of 5-8 mm ±1.5 mm and an internal diameter (ID) of 3-6 mm±1 mm configured to provide a space, small enough to make low volumes of liquid available for auto-injector needle. The height of the microampule is between 40 mm±4mm-100 mm±4 mm. The microampule has a bottom portion 101 as a scoring height and a top portion 102 as a spacer. The bottom portion 101 and the top portion are spaced apart at a scoring point 104. The top portion of the microampule acts as a handle so that the longer length of the spacer 102 provides a space to apply the force to snap break the seal at the opening level of the autosampler vial.

The bottom portion 101 has a scoring height of 32-25 mm and serves as the sample container 300 and the top portion 102 serves as a spacer. The “microampule” is scored by a diamond scoring tool at the height of 25 mm-33 mm so that after breaking the ampoule 100, the opening of the insert aligns with the opening of the autosampler vial 400 for screw capping. The top portion 102 of the microampule works as a spacer to prevent the heat to spread down to the liquid 300 when heat sealing the ampule. The top portion 102 of the microampule further acts as a handle. The longer length of the microampule 100 provides a space to apply the force to break the microampule 100 at a certain position on the walls so that its opening aligns with the opening of the autosampler vial 400 for tight screw capping or crimp capping. The microampule is suitable to store air sensitive material such as analytical standards and biopharmaceuticals in volumes under 300 μl.

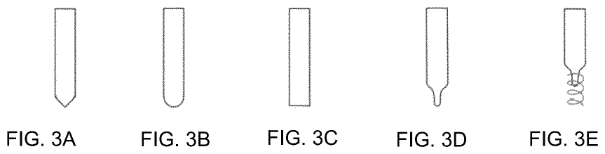

As shown in FIGS. 3A to 3E the microampule 100 is made by closing the bottom end of a glass tube in various shapes. As shown in FIG. 3A the bottom end can be in v-shape, or round bottom as shown in FIG. 3B, flat bottom as shown in FIG. 3c, high-recovery as shown in FIG. 3D, or spring-attached as shown in FIG. 3E, etc.

The microampule of present invention 100 uses a closed end glass or plastic container that is slim enough to hold small quantities of liquid in proper height for auto injector needle, while the tube can be used in an autosampler compatible vial acting as a holder. This makes the system: 1) sealable after packaging 2) able to hold small volumes of liquid 3) compatible with autosampler systems.

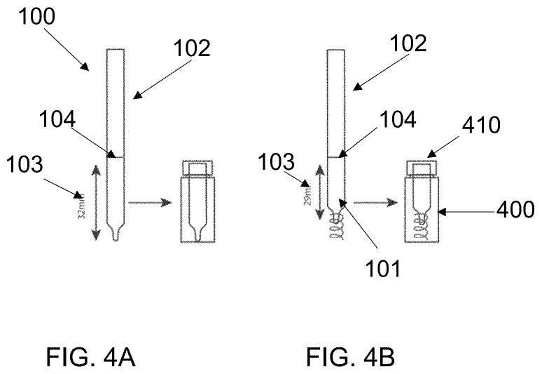

According to FIGS. 4A and 4B the microampule has a scoring height 103. The scoring height 103 depends on the shape of the microampule 100. According to FIG. 4B if the microampule 100 is spring-attached to push the insert up, then the scoring point 104 would be closer to the bottom portion 101. The tube should be scored by a scoring tool to allow removal of the spacer 102. The scoring could be made at the manufacturing step or by the end user.

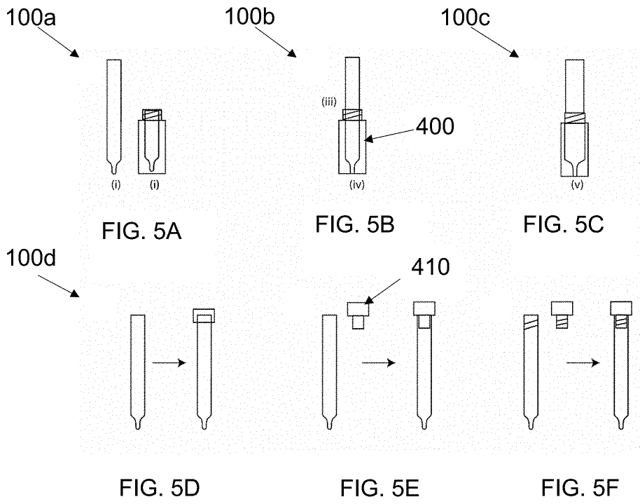

According to FIGS. 2 and 5A in manufacturing 60 the Microampule can be made as a stand-alone microampule 100a and independent of the autosampler vial 400, or fused to the autosampler vial 100b as shown in FIGS. 5B and 5C. The fusion can happen by fusing an individual microampule with an individual autosampler. In this case the microampule is made independent of the autosampler vial and is then fused to the autosampler vial or by making an autosampler vial that contains the microampules in its primary body at the moulding step (as shown in FIG. 5C). In this case the microampule 100c is a part of the autosampler vial design and makes a seamless assembly.

According to FIGS. 5D to 5F the Microampule can come in a single piece 100D that can be sealed by heat-fusing at the top, or in multiple pieces where an auxiliary glass piece will act as a micro-lid 410 to close the top of the ampule before sealing.

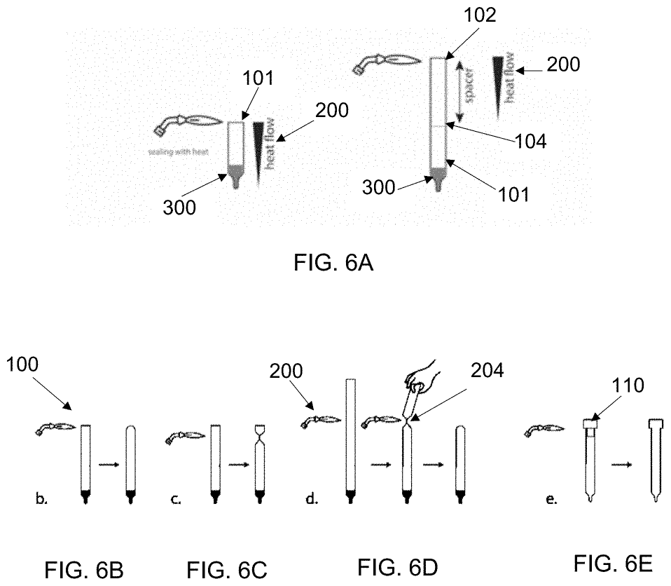

According to FIG. 6A the dimensions of the microampule is important and specific to make the microampule fit inside a 8-425/9-425/10-425 autosampler vial. The height of the microampule is also important and specific because it adds a spacer 102 to the insert. The advantage of adding the spacer is as following:
a) Increase the height of the tube which acts as a buffer to prevent the heat flow 200 to run down to microampule when the glass is being sealed by flame and therefore, to protect the containment 300 in the bottom portion 101 of the microampule from the heat damage;
b) The spacer 102 works as a handle/lever to increase the force for snap breaking the microampule with fingers at the breaking point/scoring point 104.

There are several ways to produce the microampoule with the previously specified properties and dimensions. As shown in FIG. 6B one can heat 200 the microampoule at the top until the wall of the tube melts down and collapses to passively make a seal (top seal). As shown in FIG. 6C, one can heat the tube in the middle and seal the tube by pressing the two edges of the softened microampule to fuse the building material together. As shown in FIG. 6D one can start with a longer glass tube, heat it at the sealing point 204 and then remove the top part of the long glass tube to result in the microampule. As shown in FIG. 6E, a glass lid 110 can be placed on the top of the ampule before sealing and fuse the glass of the lid to the body of micro ampule to seal the top.

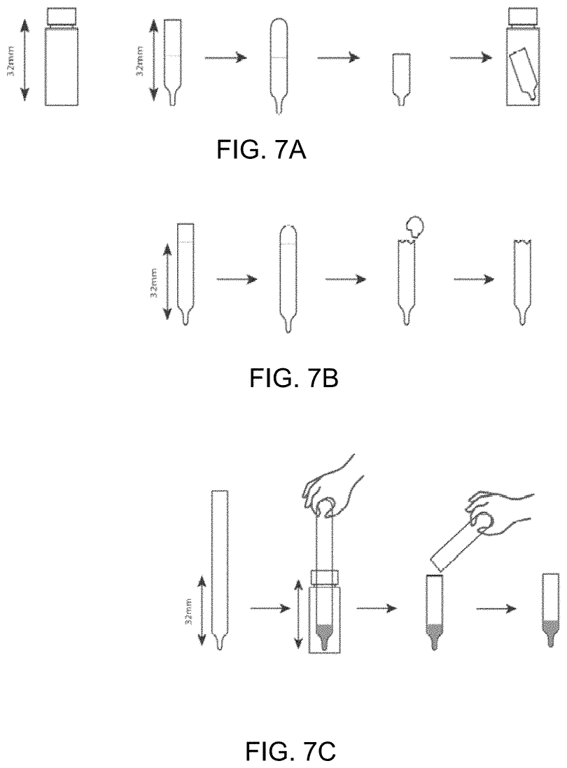

FIG. 7A shows the microampule without an spacer which is broke short and did not fit properly in the autosampler vial to show the advantage of adding a top spacer to allow the sealed microampule snap break at the right position to fit in an autosampler vial. If the spacer is not present, the user can not break the glass at the scoring point without damaging the tube. FIG. 7B shows the microampule with a short spacer which by breaking may cause chopped edges or destroy the microampule.

FIG. 5C shows the advantage of adding a right length for the top spacer to allow the sealed microampule snap break at the right position to fit in an autosampler vial. It is important to mention that the specified height of the tube and the specified position of the scoring point makes it possible to open the microampule by breaking the insert tube inside an autosampler vial with a height of 32 mm and mouth opening of 5-7 mm and pushing with fingers. This design makes it very simple to quickly open a sealed tube and provides it to the autosampler for analysis.

Referring to FIG. 2 the following is the process of manufacturing, packaging and using the microampule:

Packaging 70: The packaging is the process of placing the containment inside the microampule and sealing it for the purpose of storage. It takes place in two main steps:
a) Adding (inserting) the containment (liquid or solid) to the microampule: The insertion process can be done at the manufacturing facility where the samples are prepared for the end user working out of the facility, or in a lab where the packaging person is the same as the end user. Placing the sample inside the microampule can be accomplished by a human using a pipette or by machine. The added volume is typically under 200 μl.
b) Sealing the microampule at the top using heat. If glass is used as the packaging material, the microampule can be sealed by flame, plasma arc, metal element, or any other device that can melt the glass to bind it together for sealing. If plastic is used any low heat generating device such as hot press, flame, heat gun, etc. could be used to seal the microampule. The sealing process removes the change of air exchange between the sample and the environment to zero.

Point of use 80: To use the microampule, the user has to break the glass or plastic to expose the containment to the autosampler. The microampule is designed to work with autosampler systems that use autosampler vials. Although glass inserts are being used widely in the industry, autosampler trays that hold insert by itself are not readily available. The common practice is to open a screw cap autosampler vial, place the insert inside the vial and then cap the vial. In this fashion, the vial works as a holder for the insert. The auto-injector needle can access the containment by piercing through the cap septum at the center and aspirating the liquid.

The design of the microampule makes it possible for the user to snap break the glass with ease by: placing the insert inside the vial, aligning the scoring point with the opening of the vial and gently pushing the spacer against the wall of the vial. The spacer will be discarded and the insert which perfectly fits inside the vial after capping and can hold small quantities of the liquid. The specification of the design renders the microampule a new ready-to-use packaging system where the sample is ready by a simple snap break. It is important that the glass is scored at the right position on the insert, otherwise the insert will be too long to screw cap the vial or it would be too short for the needle to safely access it.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A microampule and vial device, comprising:
a microampule that is divided into a top portion with a top-height and a bottom portion with a bottom-height, which are divided by a scoring line to allow for the breakage of the microampule, wherein the bottom portion is configured to hold a fluid, and
a vial configured to receive and hold the bottom portion of the microampule, the vial having a vial-height that matches a bottom-height of the microampule and wherein the top portion of the microampule sticks out of the vial,
whereby the top portion of the ampule is used as a handle to apply a force to break off the top portion from the scoring line, thereby allowing access to the fluid in the bottom portion.

2. The microampule and vial device of claim 1, wherein the vial is configured to receive a sealable cap once the top portion of the microampule is broken off.

3. The microampule and vial device of claim 1, wherein the vial is fused to the microampule just below the scoring line.

4. The microampule and vial device of claim 1, wherein the bottom of the bottom portion has a V-shaped, round shaped, flat shaped or narrow shaped for high recovery.

5. The microampule and vial device of claim 1, further having a spring placed inside the vial, wherein the bottom of the bottom portion engages with the spring to push the microampule upwards.

6. The microampule and vial device of claim 1, wherein the microampule is cylindrical.

7. The microampule and vial device of claim 1, wherein the microampule is made from glass, plastic or ceramic, and can contain borosilicate, lime soda and lead, and can be clear or colored.

8. The microampule and vial device of claim 1, wherein the height of the microampule is between 40 mm to 100 mm.

9. The microampule and vial device of claim 1, wherein the outer diameter of the microampule is between 5 mm to 8 mm and an internal diameter of the microampule is between 3 mm to 6 mm.

10. The microampule and vial device of claim 1, wherein the dimension of the microampule is configured to store air sensitive material comprising material for analytical standards and biopharmaceuticals in volumes less than 300 μl.

11. A method for manufacturing a sealable and vial compatible microampule, comprising:
making a microampule by closing a bottom of a glass tube;
placing a specified volume of a fluid inside the microampule;
heating and closing a top of the microampule;
scoring the microampule at a scoring height to divide the microampule into a top portion and a bottom portion,
placing the microampule inside a vial.
